(19) United States
(12) Patent Application Publication
(10) Pub. No.: US 2007/0288835 A1
(43) Pub. Date: Dec. 13, 2007

(54) APPARATUS, COMPUTER READABLE MEDIUM, DATA SIGNAL, AND METHOD FOR DOCUMENT MANAGEMENT

(75) Inventor: Takehito Watanabe, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/608,892

(22) Filed: Dec. 11, 2006

(30) Foreign Application Priority Data
Jun. 7, 2006 (JP) 2006-158246

(51) Int. Cl. G06F 17/00

(52) U.S. Cl. 715/500; 715/530

(57) ABSTRACT

There is provided a document management apparatus including a copy document creation unit that retrieves an electronic shared document from a document memory and creates a document for edit which is to be transmitted to the user by copying the retrieved electronic document; a preliminary document creation unit that, before the document for edit is edited by the user, creates a preliminary document by copying the document for edit; an update detection unit that, when the user requests to store a document in the document memory, detects content which is edited by the user by comparing the document for edit with the preliminary document corresponding to the document for edit; and a document update unit that, when edited content is detected, updates an electronic document which is stored in the document memory and is corresponding to the document for edit with the detected edited content.

### PRIORITY INFORMATION

This application claims priority to Japanese Patent Application No. 2006-158246, filed on Jun. 7, 2006.

### BACKGROUND

1. Technical Field

The present invention generally relates to the management of an electronic document which is simultaneously edited by multiple users.

2. Related Art

Conventionally, there are systems for editing or systems for reviewing a shared electronic document by multiple users. In these systems, when the multiple users edit the electronic document simultaneously, a problem may occur where consistency of the shared document cannot be maintained because of conflict between the respective edits of the users.

However, the technology of the patent document 1 provides a negative method in which conflict is resolved by preventing users from editing simultaneously, and does not actually allow simultaneous multiple edits. On the other hand, the technology of patent document 2 allows a simultaneous editing environment to be provided. However, when a document is edited utilizing a document editing application in which an update cannot be detected, a situation has arisen in which it could not be ensured that the conflict is resolved. This will now be described using specific examples.

FIG. 11 is a conceptual diagram showing transitions of content in each document in the case where two users A and B simultaneously edit a shared document utilizing a related art.

First, at time T1 respective copy documents of the shared document are created for users A and B. After the creation of the copy documents, the user B edits an existing annotation which is included in the copy document at time T2. After the editing, the user B it is assumed that the user will attempt to store the document. At this time, because an annotation “XXX” of the shared document and an annotation “YYY” of the copy document for the user B are different, as shown at time T3 the annotation of the shared document is updated with the edited content by the user B in a conventional manner. Thereafter, although the user A has not edited the existing annotation “XXX”, because the user A has edited another part of the document, the user A has attempted to store the document. At this time, because the annotation “YYY” of the shared document and the annotation “XXX” of the copy document for the user A are different, as shown at time T4 the annotation of the shared document is updated with the annotation “XXX” of the copy document for the user A in the conventional manner.

### SUMMARY

According to one aspect of the invention, there is provided a document management apparatus including: a copy document creation unit that retrieves an electronic document to be edited by a user from a document memory that stores an electronic document shared by a plurality of users, and creates a document for edit which is to be transmitted to the user by copying the retrieved electronic document; a preliminary document creation unit that, before the document for edit is edited by the user, creates a preliminary document corresponding to the user and to the document for edit by copying the document for edit; a preliminary document hold unit that holds the created preliminary document; an update detection unit that, when the user requests to store a document for edit in the document memory, detects content which is edited by the user by comparing the document for edit with the preliminary document corresponding to the document for edit; and a document update unit that, when edited content is detected by the update detection unit, updates an electronic document which is stored in the document memory and is corresponding to the document for edit, with the detected edited content.

### BRIEF DESCRIPTION OF THE DRAWINGS

Exemplary embodiments of the present invention will be described in detail based on the following figures, wherein:

FIG. 1 is a block schematic diagram showing a shared document processing system in accordance with an exemplary embodiment of the present invention;

FIG. 2 is a diagram showing an example data structure of a document table which is included in a document database in accordance with an exemplary embodiment of the present invention;

FIG. 3 is a diagram showing an example data structure of an annotation table which is included in a document database in accordance with an exemplary embodiment of the present invention;

FIG. 4 is a hardware configuration diagram of a document management server in accordance with an exemplary embodiment of the present invention;

FIG. 5 is a conceptual diagram showing transitions of content of each document when two users A and B simultaneously edit an annotation which is added to a shared document in accordance with an exemplary embodiment of the present invention;

FIG. 6 is a flow chart showing a process when a user starts editing of an electronic document in accordance with an exemplary embodiment of the present invention;

FIG. 7 is a flow chart showing a process when a request to store a document is sent from a user in accordance with an exemplary embodiment of the present invention;

FIG. 8 is a flow chart showing an update detection process which is included in the process shown in FIG. 7;

FIG. 9 is a flow chart showing an update reflection process which is included in the process shown in FIG. 7;

FIG. 10 is a conceptual diagram showing transitions of content of each document when two users A and B simultaneously edit a body of a shared document in accordance with an exemplary embodiment of the present invention; and

FIG. 11 is a conceptual diagram showing transitions of content of each document when two users A and B simultaneously edit a shared document in a related art.

### DETAILED DESCRIPTION

With reference to the drawings, exemplary embodiments of the present invention will be described below.

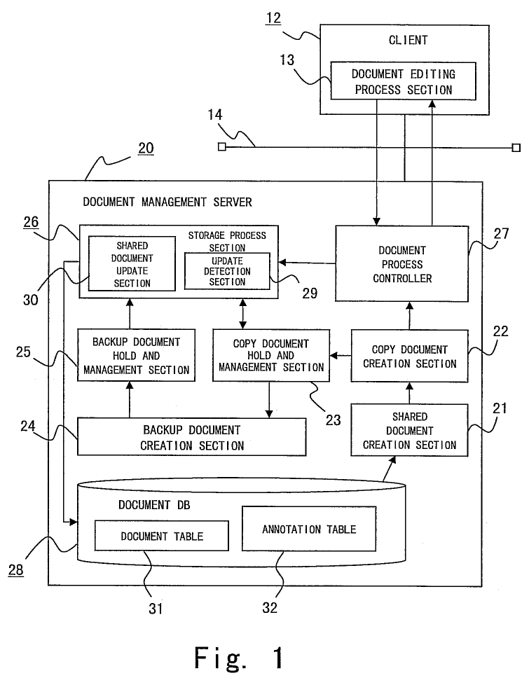

FIG. 1 is a block schematic diagram showing a shared document processing system in accordance with an exemplary embodiment of the present invention. FIG. 1 shows a client 12 which is used by a user who shares an electronic document and a document management server 20 which holds and manages a shared electronic document (shared document), each of which is connected by a network 14 so as to be able to exchange information.

The client 12 has a document editing process section 13 which is realized by executing a document editing application in which an update cannot be detected, and edits the shared document which is held and managed by the document management server 20. It should be noted that in the exemplary embodiment of the present invention because the same shared document is simultaneously edited by multiple users, there are multiple clients 12 included, but only one client 12 is shown in FIG. 1 since all the respective clients 12 may have the same configuration.

The document management server 20 is an apparatus corresponding to the shared document management apparatus in accordance with the present invention, and includes a shared document creation section 21, a copy document creation section 22, a copy document hold and management section 23, a backup document creation section 24, a backup document hold and management section 25, a storage process section 26, and a document process controller 27. In the exemplary embodiment of the present invention, because a body of the electronic document and an annotation are managed separately, the shared document creation section 21 retrieves the electronic document and the annotation which are simultaneously edited by the multiple users from a document database 28, and adds the annotation to the electronic document to create the shared document. The copy document creation section 22 creates a copy document of the shared document for each user. The copy document hold and management section 23 holds and manages the copy document which is created for each user by the copy document creation section 22. The backup document creation section 24 creates a backup document for each user by further replicating the copy document which is created for each user by the copy document creation section 22. The backup document hold and management section 25 holds and manages the backup document which is created for each user by the backup document creation section 24. The storage process section 26 is a unit that performs a storage process of the copy document in response to a document storage request from a user, and includes an update detection section 29 and a shared document update section 30. The update detection section 29 compares a copy document which is sent from the client 12 used by either user for storing the document with the backup document of the copy document, to detect the content which is edited by the user in the copy document. The shared document update section 30 updates the electronic document, which is stored in the document database 28,+ by reflecting the edited content in the copy document, which is detected by the update detection section 29, in the shared document which is the original of the copy document. The document process controller 27 exchanges information with the client 12, and performs process control of the entire document management process which is performed by the document management server 20. Specifically, in response to a document acquisition request from the user, the corresponding shared document is sent to the client 12 which is used by the user. Also, in response to a document storage request from the user, the storage process section 26 is caused to perform a storage process of the copy document.

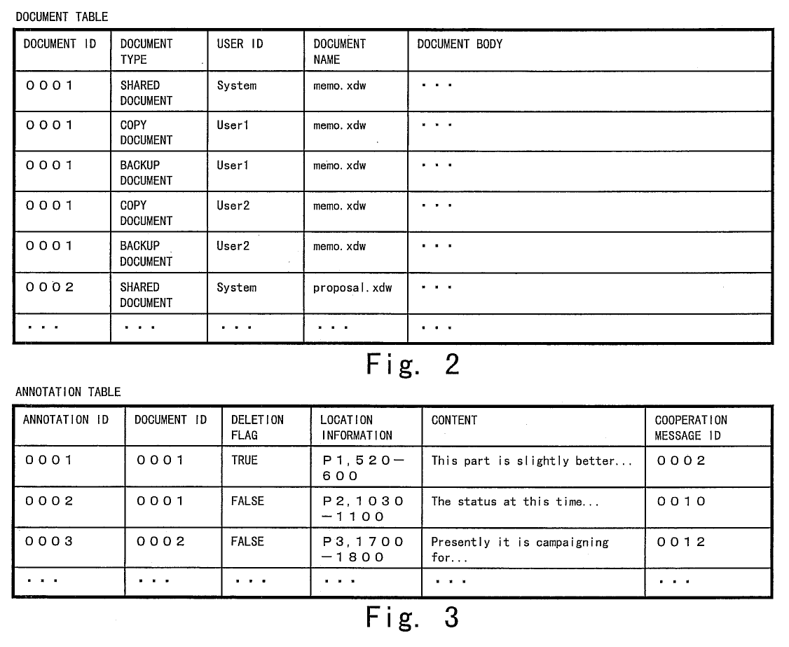

FIG. 2 is a diagram showing an example data structure of a document table 31 which is included in the document database 28 in accordance with an exemplary embodiment of the present invention. Each record registered in the document table 31 is created for each document. For each record, a document ID which identifies a document, a document type which indicates a type of the document, a user ID which indicates identification information of a document owner, a document name and a body of the document are created correspondingly.

FIG. 3 is a diagram showing an example data structure of an annotation table 32 which is included in the document database 28 in accordance with an exemplary embodiment of the present invention. Each record registered in the annotation table 32 is created for each annotation. Each record is created in association with an annotation ID which identifies an annotation, a document ID which identifies the document, a deletion flag which indicates whether the annotation is deleted or not, location information for identifying a location for where to add the annotation on the electronic document, actual content described as the annotation for the user, and a cooperation message ID to be associated with an external message correspondingly.

In the exemplary embodiment of the present invention, an electronic document and an annotation which is added to the electronic document are held and managed separately by providing the respective tables 31 and 32 mentioned above. The electronic document and the annotation are associated each other by the document ID.

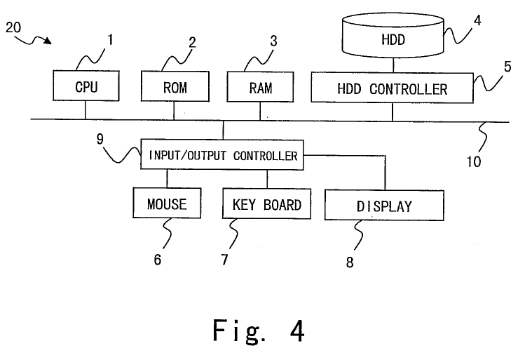

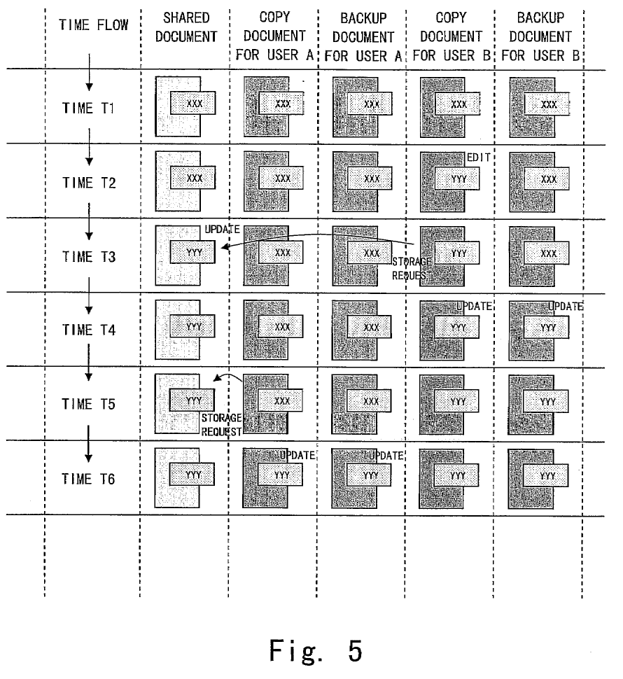

FIG. 4 is a hardware configuration diagram of the document management server 20 in accordance with an exemplary embodiment of the present invention. The document management server 20 in accordance with the exemplary embodiment can be realized by the hardware configuration which is held by a general purpose server computer which has existed heretofore. That is, as shown in FIG. 4 the document management server 20 is configured by connecting a CPU 1, a ROM 2, a RAM 3, a hard disk drive (HDD) controller 5 which connects a HDD 4, and an input/output controller 9 which connects a mouse 6 and a key board 7 provided as input units and a display 8 provided as a display device to an internal bus 10. It should be noted that because the client 12 is realized by a general purpose personal computer (PC) the basic configuration of the hardware is similar to that of FIG. 4 even though there are differences of performance or the like.

The respective components 21-27 in the document management server 20 are realized by cooperative operations between a computer embedded in the document management server 20 and programs executed by a CPU embedded in the computer. In addition, the document database 28 is realized by an external storage device embedded in the document management server 20. It should be noted that the document database 28 may not be embedded in the document management server 20, but maybe configured to be accessible through the network 14. The program used in the exemplary embodiment can not only be provided through a communication unit of course, but also provided by storing in a storage medium such as a CD-ROM. In addition, the component in the client 12 is realized by cooperative operations between a computer embedded in the client 12 and programs executed by a CPU embedded in the computer.

Next, operations in accordance with an exemplary embodiment of the present invention will be described. First, the basic operations in accordance with the exemplary embodiment will be described with reference to FIG. 5 which corresponds to the related art of FIG. 11.

First, at time T1 respective copy documents which are used by users A and B are created from an identical shared document, and the respective copy documents for the respective users A and B are further replicated to create backup documents. At time T2 the user B edits an existing annotation included in the copy document, and at time T3 the user B has attempted to store the document. At this time, because the annotation “YYY” of the copy document for the user B and the annotation “XXX” of the backup document for the user B are different, it can be recognized that the annotation has been edited by the user B. Therefore, in accordance with the exemplary embodiment, as shown at time T3 the annotation of the shared document is updated with the edited content by the user B. After that, as shown at time T4 a copy document of the updated shared document is created for the user B who requested to store the document, and the copy document is further replicated to create a backup document.

At time T5, although the user A has not edited the existing annotation “XXX”, because the user A has edited another part of the document, the user A has attempted to store the document. At this time, because the annotation “XXX” of the copy document for the user A matches the annotation “XXX” of the backup document for the user A, it can be recognized that the annotation has not been edited by the user A. Therefore, in accordance with the exemplary embodiment, as shown at time T5 the annotation of the shared document is not updated with the edited content by the user A even if there is a storage request. After that, as shown at time T6 a copy document of the updated shared document is created for the user A who requested to store the document, and the copy document is further replicated to create a backup document.

In accordance with the exemplary embodiment, because the system operates as mentioned above, the content edited by the user can be reflected in the shared document and the shared document may not be updated when the user has not edited. Because of the above reason, the identical shared document can be simultaneously edited by multiple users without generating a problem.

It should be noted that at time T4, when it is requested to store the document, the copy document and further the backup document for the user B who requested to store the document are created from the shared document. Because the shared document has been updated with the edited content by the user B, the creation process of the copy document is considered to be actually an unnecessary process since the copy document for the user B is to be overwritten with the shared document with the identical content. However, the process at this time is performed for convenience of the program by making the same routine as that at time T6. When the size of the shared document is large, the processing efficiency is considered to be improved in the case where the copy document is intentionally not created. Of course the creation process of the backup document is essential. Because the backup document is also considered as a backup of the copy document, it is appropriate to replicate the copy document to create the backup document, and thus it is processed in such a manner in the exemplary embodiment. However, the shared document may be replicated to create the copy document and the backup document.

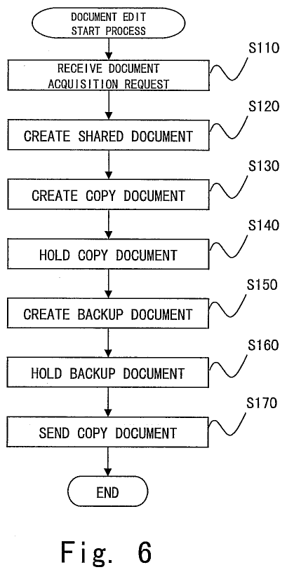

Next, the details of the operations in accordance with the exemplary embodiment of the present invention will be described with reference to respective flow charts. In accordance with the exemplary embodiment, the process is broadly classified into a document edit start process in which an electronic document is obtained from the document management server 20 for the review or the like by the user who uses the client 12, and a document storage process in which the obtained electronic document is stored. First, the process at the time when the user starts to edit the electronic document will be described with reference to a flow chart shown in FIG. 6.

In the document management server 20, the document process controller 27 receives a document acquisition request in which document identification information, for example document identification information such as a document name, is specified from the client 12 (step 110). The shared document creation section 21 retrieves from the document database 28 a body of an electronic document which can be identified by the document identification information and an annotation which can be identified by a document ID of the electronic document in response to an instruction from the document process controller 27, and creates a shared document by integrating the electronic document and the annotation (step 120). When the shared document is created, the copy document creation section 22 creates a copy document for editing by the user by replicating the shared document (step 130). When the copy document creation section 22 creates the copy document, the copy document hold and management section 23 holds the created copy document (step 140). When the copy document hold and management section 23 holds the copy document, the backup document creation section 24 creates the backup document by replicating the held copy document (step 150). When the backup document creation section 24 creates the backup document, the backup document hold and management section 25 holds the created backup document (step 160). On the other hand, when the copy document creation section 22 creates the copy document, the document process controller 27 sends the created copy document to the client 12 which is the transmitter of the document acquisition request (step 170). It should be noted that although the process on the flow chart has been described by using the procedure mentioned above, the document processes (step 140-160) and the transmission process (step 170) after the creation of the copy document can be simultaneously performed. Thus the client 12 can obtain the shared document for edit, to put it more precisely, the copy document of the shared document.

In addition, when the other user sends the document acquisition request, the document acquisition process mentioned above is performed, and a copy document of the shared document and a backup document are created for each user. Therefore, respective document hold and management sections 23 and 25 hold and manage the user ID of the copy document owner and the copy document by association to be able to determine the owner of each copy document. By performing the document edit start process in response to the document acquisition request by the users A and B, the state shown at time T1 in FIG. 5 is provided.

The document editing process section 13 in the client 12 performs an editing process to the received shared document in response to the user operation. For example, the user B is assumed to edit an annotation “XXX” into “YYY”. When the document is edited by the user B, the content of each document goes into the state shown at time T2 in FIG. 5.

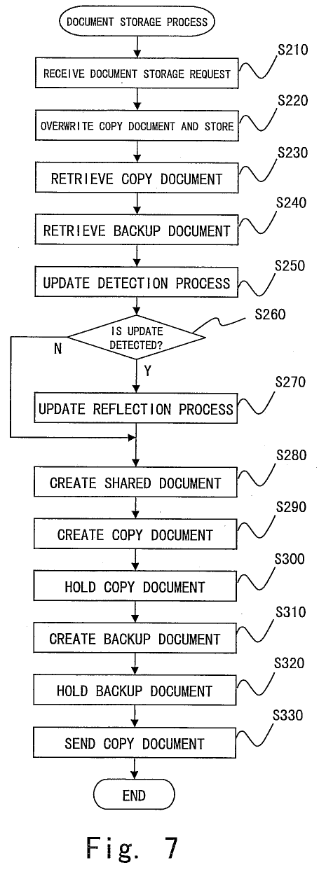

Next, a document storage process which is performed by sending a document acquisition request to the document management server 20 after storing the electronic document edited by the user B in the client 12 will be described with reference to the flow chart shown in FIG. 7.

In the document management server 20, the document process controller 27 receives a document acquisition request in which document identification information, for example document identification information such as a document name is specified or a body of the electronic document is added from the client 12 (step 210). The storage process section 26 overwrites the copy document which will be the original of the electronic document held by the copy document hold and management section 23 with the electronic document which is obtained from the client 12 in response to an instruction from the document process controller 27 and stores the overwritten copy document (step 220). To put it more specifically, the storage process section 26 can identify which copy document is to be overwritten by comparing and checking the user ID which is sent together with the electronic document obtained from the client 12 with the user ID of the copy document held by the copy document hold and management section 23. It should be noted that the copy document to be overwritten can be identified by checking, in addition, the document ID and the like if the user B simultaneously processes multiple electronic documents.

Next, the update detection section 29 in the storage process section 26 retrieves the overwritten and stored copy document from the copy document hold and management section 23 (step 230), retrieves a backup document corresponding to the overwritten and stored copy document from the backup document hold and management section 25 (step 240), and detects whether the user B has edited or not by comparing and checking the backup document with the copy document (step 250). To put it more specifically, the presence or absence of editing is detected by comparing and checking the electronic document sent to the client 12 used by the user B in the document edit start process or the backup document of the copy document held by the copy document hold and management section 23 with the electronic document received from the user B in the document storage process or the overwritten and stored copy document held by the copy document hold and management section 23. It should be noted that the details of the process for the update detection in step 250 will be described later on. It should be noted that as illustrated in FIG. 5, when the presence or absence of editing of the annotation is detected, after the respective annotations are separated from the bodies of the electronic documents for the copy document and the backup document, the annotations are compared.

If it is recognized that the electronic document (the body and/or the annotation of the electronic document) is updated by the user B based on the detection process (Y in step 260), the shared document update section 30 updates the electronic document by reflecting the content edited by the user B (step 270). To put it more specifically, because the document database 28 holds the body and the annotation of the electronic document separately, the shared document update section 30 updates the document table 31 and the annotation table 32 by separating the electronic document edited by the user B into the document body portion and the annotation respectively. In the example shown in FIG. 5, because the user B has edited only the annotation, the shared document update section 30 may update only information related to the edited annotation. It should be noted that the details of the process which updates the shared document with the content edited by the user in step 250 will be described later on. By updating the shared document stored in the document database 28 in such a manner, the shared document goes into the state shown at time T3 in FIG. 5.

The subsequent process is essentially the same as that of steps 120-170 at the time of the document acquisition request. More specifically, the shared document creation section 21 creates a shared document in response to an instruction from the document process controller 27 (step 280), the copy document creation section 22 creates a copy document for editing by the user B by replicating the shared document (step 290), and the copy document hold and management section 23 holds the copy document (step 300). In addition, the backup document creation section 24 creates a backup document by replicating the held copy document (step 310), and the backup document hold and management section 25 holds the created backup document (step 320). On the other hand, the document process controller 27 sends the copy document created by the copy document creation section 22 to the client 12 which is the transmitter of the document storage request (step 330). By performing the document storage process, the documents are placed in the state shown at time T4 in FIG. 5.

When the user B further wishes to perform an editing process on the shared document, the document editing process section 13 in the client 12 will open the shared document in response to a user operation, but because the electronic document sent to the document management server 20 has already been stored and closed, the electronic document which will be opened at this time is (the copy document of) the shared document in which the editing performed by the user himself or herself has been reflected.

After the editing process and the storage process of the electronic document mentioned above are performed by the user B, the user A stores the electronic document in the client 12. A document storage process, which is performed by sending a document storage request to the document management server 20 by the user A after they store the electronic document in the client 12, will be described with reference to the flow chart shown in FIG. 7. It should be noted that repeated description of processes will be omitted as required.

In the document management server 20, when the document process controller 27 receives the document storage request from the client 12 (step 210), the storage process section 26 overwrites the copy document of the user A which is held by the copy document hold and management section 23 with the electronic document obtained from the client 12 and stores the overwritten document (step 220). Next, the update detection section 29 in the storage process section 26 detects whether the user A has edited or not by comparing and checking between the copy document and the backup document which are retrieved from the respective document hold and management section 23 and 25 respectively (step 230-250). Here, the user A is assumed to have not edited the annotation “XXX.”

The update detection section 29 detects the presence or absence of the editing by comparing and checking the electronic document sent to the client 12 used by the user A in the document edit start process or the backup document of the copy document held by the copy document hold and management section 23 with the electronic document received from the user A in the document storage process or the overwritten and stored copy document held by the copy document hold and management section 23. Therefore, in this example with the user A, because both the annotation in the document editing start process and the annotation received in the document storage process are “XXX” as shown at time T5 in FIG. 5, it can be recognized that the document has not been updated. Thus the update reflection process in the shared document (step 270) will be skipped as shown in FIG. 7. Therefore, even if the copy document which is included in the copy document hold and management section 23 is overwritten with the electronic document which is sent from the user A to the copy document hold and management section 23 and the overwritten document is stored, the annotation of the shared document will not be updated as shown at time T5 in FIG. 5.

The subsequent process is the same as that for the user B. More specifically, the shared document creation section 21 creates a shared document in response to an instruction from the document process controller 27 (step 280). Because the update by the user B has been reflected in the shared document created here, the content of the annotation is “YYY.” Next, the copy document creation section 22 creates a copy document for editing by the user A by replicating the shared document (step 290), and the copy document hold and management section 23 holds the copy document (step 300). In addition, the backup document creation section 24 creates a backup document by replicating the held copy document (step 310), and the backup document hold and management section 25 holds the created backup document (step 320). On the other hand, the document process controller 27 sends the copy document created by the copy document creation section 22 to the client 12 which is the transmitter of the document storage request (step 330). By performing the document storage process, the documents are placed in the state shown at time T6 in FIG. 5.

When the user A further wishes to perform an editing process on the shared document, the document editing process section 13 in the client 12 will open the shared document in response to a user operation, but because the electronic document sent to the document management server 20 has already been stored and closed, the electronic document which will be opened at this time is (the copy document of) the shared document newly sent from the document management server 20, and is the shared document in which the editing performed by the user B has been reflected.

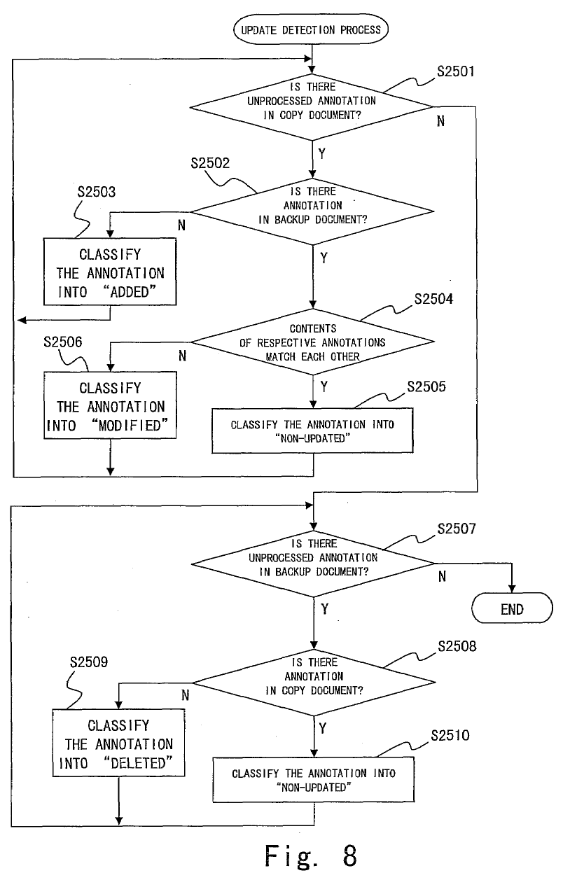

The update detection process in FIG. 7 will now be described with reference to the flow chart shown in FIG. 8. This process is based on the process which detects whether or not each of the multiple annotations which are added to the shared document has been updated by comparing and checking the copy document with the backup document.

The update detection section 29 repeats the following process until no unprocessed annotation remains. First, the presence or absence of the unprocessed annotation is determined and the unprocessed annotation is extracted in the copy document. If there is no unprocessed annotation (N in step 2501), the process proceeds to step 2507. If there is an annotation (Y in step 2501), it is determined whether there is an annotation corresponding to the extracted annotation in the backup document. If there is no corresponding annotation (N in step 2502), the extracted processing target annotation would be the annotation which has been newly added as a result of editing work by the user. Therefore, the processing target annotation is classified into an “added” group (step 2503). On the other hand, if there is an annotation corresponding to the processing target annotation in the backup document (Y in step 2502), it is determined whether the contents of the respective corresponding annotations match each other. If they match (Y in step 2504), because it can be determined that the annotation has not been edited by the user, the processing target annotation is classified into a “non-updated” group (step 2505). If they do not match (N in step 2504), because it can be determined that the annotation has been edited by the user, the processing target annotation is classified into a “modified” group (step 2506).

In step 2501, if it is determined that there is no unprocessed annotation in the copy document, the process is then directed to the backup document. Next, in the backup document, the presence or absence of the unprocessed annotation is determined and the unprocessed annotation is extracted in the backup document. If there is no unprocessed annotation (N in step 2507), the process is finalized. If there is an unprocessed annotation (Y in step 2507), it is determined whether there is an annotation corresponding to the extracted annotation in the copy document. If there is no corresponding annotation (N in step 2508), the extracted processing target annotation would be the annotation which has been deleted as a result of editing work by the user. Therefore, the processing target annotation is classified into a “deleted” group (step 2509). On the other hand, if there is an annotation corresponding to the processing target annotation in the copy document (Y in step 2508), because the processing target annotation has already been classified into either group in steps. 2504-2506, essentially there is no need to process, but here it is intended to perform the process in which the processing target annotation is classified into the “non-updated” group (step 2510).

As described above, in the exemplary embodiment, not only is the presence or absence of the update detected, but the update type is also determined.

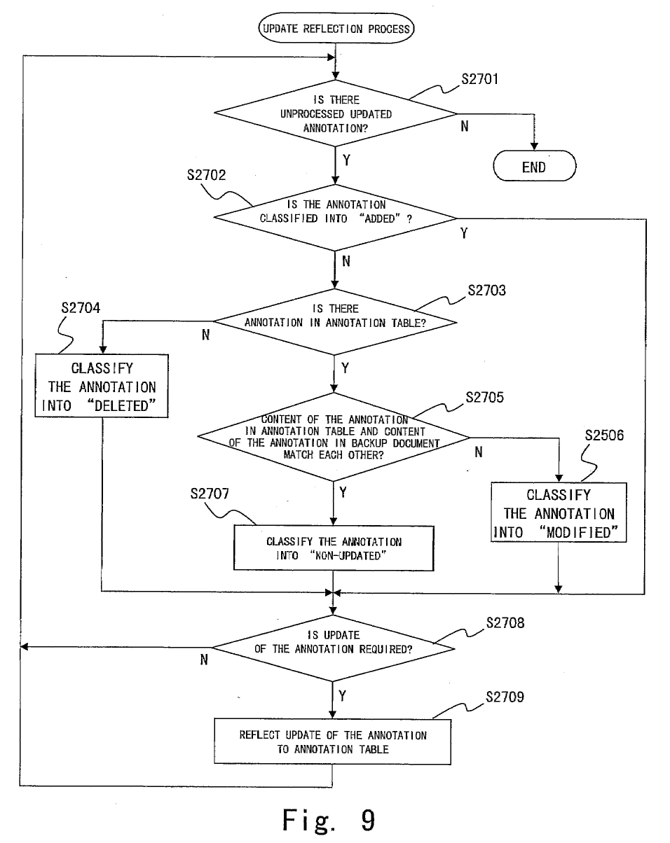

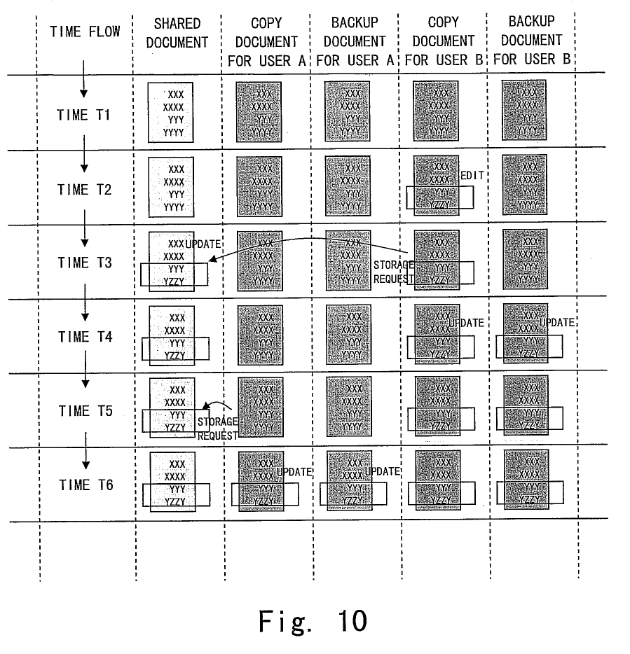

Next, the update reflection process in FIG. 7 will be described with reference to the flow chart shown in FIG. 9. Essentially, although the process corresponding to only the annotations which are classified into “added”, “modified”, and “deleted” groups may be performed to the annotation table 32, in the exemplary embodiment the process also including annotations which are detected as the “non-updated” group is performed in the following procedure.

The shared document update section 30 repeats the following process until no unprocessed annotation whose update is detected in the update detection process remains. First, if there is no unprocessed annotation (N in step 2701), the process is finalized. If there is an unprocessed annotation (Y in step 2701), and if the processing target annotation is classified into the “added” group (Y in step 2702), the process proceeds to step 2708. If the processing target annotation is not classified into the “added” group (N in step 2702), then it is determined whether the processing target annotation is registered with the annotation table 32. If the processing target annotation is not registered (N in step 2703), the processing target annotation is classified into the “deleted” group from the annotation table 32 (step 2704). If the processing target annotation is registered (Y in step 2703), it is determined whether the content set in the annotation table 32, this content corresponding to the annotation, and the content which is added to the backup document, match each other. If they do not match (N in step 2705), because it can be determined that the processing target annotation has been modified, the annotation which is included in the annotation table 32 is classified into the “modified” group. If they match (Y in step 2705), because it can be determined that the processing target annotation has not been edited by the user, the processing target annotation is classified into the “non-updated” group (step 2507).

As described above, each annotation can be classified, and the shared document update section 30 determines whether or not an update of the processing target annotation is required with reference to the result of classification into the “added”, “modified”, “deleted” and “non-updated” groups. More specifically, if the update is not required or if the annotation is classified into the “non-updated” group (N in step 2708), then the process proceeds to the next annotation process without updating the set content in the annotation table 32. If it is determined that the update is required (Y in step 2708), then the annotation table 32 is updated depending on the classified group, as in the following (step 2709). Namely if the classified group is the “added” group, information associated with the annotation is set and registered in the annotation table 32, and if the classified group is the “modified” group, information associated with the existing annotation which is set in the annotation table 32 is updated. In addition, if the classified group is the “deleted” group, the record of the annotation is not deleted, but the annotation is set to a deleted state by changing the deletion flag which is included in the record of the annotation from “FALSE” to “TRUE.”

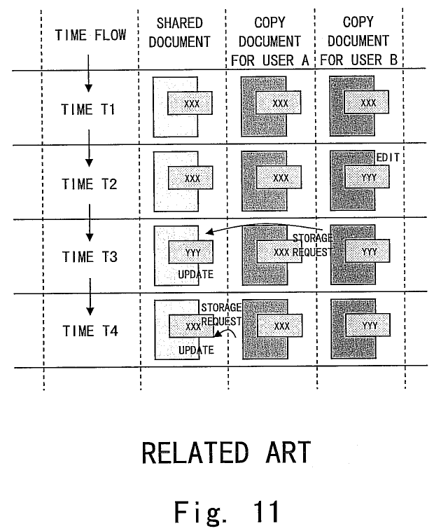

In accordance with the exemplary embodiment of the present invention, as described above, simultaneously editing work in a shared document by multiple users can be performed without problems. It should be noted that in the above description the update of the annotation is described as an example, but the body of the document can also be handled in a similar manner. For example, as illustrated in FIG. 10, the document can be grouped, for example by dividing on a paragraph by paragraph basis. If the document is divided into multiple portions in this manner, each divided group can be handled in the same manner as the annotation. In other words, the exemplary embodiment is not limited to the application to the annotation.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a copy document creation unit that retrieves an electronic document to be edited by a user from a document memory that stores an electronic document shared by a plurality of users, and creates a document for edit which is to be transmitted to the user by copying the retrieved electronic document;
a preliminary document creation unit that, before the document for edit is edited by the user, creates a preliminary document corresponding to the user and to the document for edit by copying the document for edit;
a preliminary document hold unit that holds the created preliminary document;
an update detection unit that, when the user requests to store a document for edit in the document memory, detects content which is edited by the user by comparing the document for edit with the preliminary document corresponding to the document for edit; and
a document update unit that, when edited content is detected by the update detection unit, updates an electronic document which is stored in the document memory and is corresponding to the document for edit, with the detected edited content.

2. The document management apparatus according to claim 1, wherein:
if the document update unit has performed the update process in response to a request from a user,
the copy document creation unit retrieves an electronic document for which the update process has been performed from the document memory, and creates a document for edit by copying the retrieved electronic document;
the preliminary document creation unit creates a preliminary document corresponding to the document for edit in which the update process has been reflected; and
the preliminary document hold unit updates a preliminary document stored in the document memory with the preliminary document to which the update process has been reflected.

3. A computer readable medium storing a program causing a computer to execute a process for managing an electronic document that is stored in a memory and shared by a plurality of users, the process comprising:
retrieving an electronic document to be edited by a user from the memory and creating a document for edit which is to be transmitted to the user by replicating the retrieved electronic document;
before the document for edit is edited by the user, creating a preliminary document corresponding to the user and to the document for edit by replicating the document for edit;
storing the created preliminary document in the memory;
when the user requests to store a document for edit in the memory, comparing the document for edit with the preliminary document corresponding to the document for edit to detect edited content in the document for edit; and
when edited content is detected, updating an electronic document stored in the memory corresponding to the document for edit with the detected edited content.

4. The computer readable medium according to claim 3, wherein:
if the updating of the electronic document has been performed in response to a request from a user, the creating the document for edit and the preliminary document are performed by retrieving an electronic document for which the update process has been performed from the memory, and replicating the retrieved electronic document; and the process further comprising:
updating a preliminary document stored in the memory with the preliminary document in which the update process has been reflected.

5. A method for managing an electronic document comprising:
retrieving an electronic document to be edited by a user from the memory and creating a document for edit which is to be transmitted to the user by replicating the retrieved electronic document;
before the document for edit is edited by the user, creating a preliminary document corresponding to the user and to the document for edit by replicating the document for edit;
storing the created preliminary document in the memory;
when the user requests to store a document for edit in the memory, comparing the document for edit with the preliminary document corresponding to the document for edit to detect edited content in the document for edit; and
when edited content is detected, updating an electronic document stored in the memory corresponding to the document for edit with the detected edited content.

6. A data signal for enabling a computer to perform a process for managing an electronic document that is stored in a memory and shared by a plurality of users, the process comprising:
retrieving an electronic document to be edited by a user from the memory and creating a document for edit which is to be transmitted to the user by replicating the retrieved electronic document;
before the document for edit is edited by the user, creating a preliminary document corresponding to the user and to the document for edit by replicating the document for edit;
storing the created preliminary document in the memory;
when the user requests to store a document for edit in the memory, comparing the document for edit with the preliminary document corresponding to the document for edit to detect edited content in the document for edit; and
when edited content is detected, updating an electronic document stored in the memory corresponding to the document for edit with the detected edited content.
